(19) United States
(12) Patent Application Publication
(10) Pub. No.: US 2024/0400733 A1
(43) Pub. Date: Dec. 5, 2024

(54) ETHYLENE/1-HEXENE COPOLYMERS

(71) Applicant: Dow Global Technologies LLC, Midland, MI (US)

(72) Inventors: Bo Liu, Pearland, TX (US); Nitin K. Borse, Pearland, TX (US); Lalit Darunte, Charleston, WV (US); David M. Pearson, Lake Jackson, TX (US); Mridula Kapur, Lake Jackson, TX (US); Linfeng Chen, Missouri City, TX (US); Yongchao Zheng, Houston, TX (US); Andrew T. Heitsch, Angleton, TX (US)

(73) Assignee: Dow Global Technologies LLC, Midland, MI (US)

(21) Appl. No.: 18/699,633

(22) PCT Filed: Oct. 10, 2022
(86) PCT No.: PCT/US2022/046155

§ 371 Date: Apr. 9, 2024

Related U.S. Application Data
(60) Provisional application No. 63/256,213, filed on Oct. 15, 2021.

(51) Int. Cl. C08F 210/16; C08F 2/34; C08F 4/642; C08F 4/655; C08F 4/659; C08F 4/6592; C08L 23/08

(52) U.S. Cl. CPC C08F 210/16; C08F 2/34; C08F 4/642; C08L 23/0815; C08F 4/655; C08F 4/65904; C08F 4/65925; C08L 2205/025; C08L 2207/20

(57) ABSTRACT

Embodiments are directed towards ethylene/1-hexene copolymers made from ethylene and hexene, wherein the ethyl-CA ene/1-hexene copolymer has a density from 0.850 to 0.940 g/cm³, a melt index (I₂₁) from 0.1 to 50 dg/min, a melt index (I₂₁/I₂) ratio less than or equal to 18.5, a M_{w}(Abs)/Mₙ(Abs) from 2.0 to 3.5, a M_{z}(Abs)/M_{w}(Abs) from 1.7 to 4.5, and a cumulative detector fraction (CDF_{LS}) at a molecular weight of ≥1,000,000 g/mol of greater than 100*(0.0536−I₂₁*0.00224)%.

### FIELD OF DISCLOSURE

Embodiments of the present disclosure are directed towards ethylene/1-hexene copolymers, more specifically, ethylene/1-hexene copolymers having a number of desirable properties.

### BACKGROUND

Different polymers are made utilizing various polymerization processes and/or different reaction components. For instance, different polymers are made utilizing solution, slurry, or gas phase polymerization processes. The various polymerization processes may utilize different catalysts, for example, Ziegler-Natta catalysts, chromium-based catalysts, metallocene catalysts, or combinations thereof. The different polymerization processes and different reaction components are utilized to make polymers having varying properties. There exists a continuing need for new ethylene/1hexene copolymers.

### SUMMARY

The present disclosure provides ethylene/1-hexene copolymers made from ethylene and hexene, wherein the ethylene/1-hexene copolymer has a density from 0.850 to 0.940 g/cm³, a melt index (I₂₁) from 0.1 to 50 dg/min, a melt index (I₂₁/I₂) ratio less than or equal to 18.5, a M_{w}(Abs)/Mₙ(Abs) from 2.0 to 3.5, a M_{z}(Abs)/M_{w}(Abs) from 1.7 to 4.5, and a cumulative detector fraction (CDF_{LS}) at a molecular weight of ≥1,000,000 g/mol of greater than 100*(0.0536−I₂₁*0.00224)%.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Ethylene/1-hexene copolymers, e.g., poly(ethylene-co-1-hexene) copolymers, are disclosed herein. Advantageously the ethylene/1-hexene copolymers disclosed herein provide a combination of properties that are desirable for a number of applications. For example, the ethylene/1-hexene copolymers disclosed herein can provide desirable properties like particular CDF_{LS} values, Instrumented Dart Impact (IDI) Peak Force values, and/or melt strengths at desirable densities, melt indexes, molecular weights, high density fractions (93-119° C.), Short Chain Branching Distributions, and/or Composition Distribution Branching Indexes.

The ethylene/1-hexene copolymers disclosed herein are made utilizing a gas-phase reactor system. One or more embodiments provide that two polymerization reactors, e.g., arranged in-series, may be utilized. One or more embodiments provide that a single polymerization reactor is utilized. For instance, the ethylene/1-hexene copolymers can be made utilizing a fluidized bed reactor. Gas-phase reactors are known and known components may be utilized for the fluidized bed reactor.

As used herein an “olefin,” which may be referred to as an “alkene,” refers to a linear, branched, or cyclic compound including carbon and hydrogen and having at least one double bond. As used herein, when a polyolefin, polymer, and/or copolymer is referred to as comprising, e.g., being made from, an olefin, the olefin present in such polymer or copolymer is the polymerized form of the olefin. For example, when a copolymer is said to have an ethylene content of 75 wt % to 95 wt %, it is understood that the polymer unit in the copolymer is derived from ethylene in the polymerization reaction(s) and the derived units are present at 75 wt % to 95 wt %, based upon the total weight of the polymer.

Examples of the ethylene/1-hexene copolymers include ethylene-based copolymers, having at least 50 wt % ethylene. One or more embodiments provide that the ethylene/1-hexene copolymers can include from 50 to 99.9 wt % of units derived from ethylene based on a total weight of the ethylene/1-hexene copolymers. All individual values and subranges from 50 to 99.9 wt % are included; for example, the ethylene/1-hexene copolymers can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the ethylene/1-hexene copolymers. The ethylene/1-hexene copolymers can include from 0.1 to 50 wt % of units derived from comonomer based on the total weight of the ethylene/1-hexene copolymers. One or more embodiments provide that ethylene is utilized as a monomer and 1-hexene is utilized as a comonomer.

As mentioned, the ethylene/1-hexene copolymers disclosed herein can be made in a fluidized bed reactor. The fluidized bed reactor can have a reaction temperature from 70 to 95° C. All individual values and subranges from 70 to 95° C. are included; for example, the first fluidized bed reactor can have a reaction temperature from a lower limit of 70, 73, or 75° C. to an upper limit of 95, 90, or 88° C.

The fluidized bed reactor can have an ethylene partial pressure from 125 to 275 pounds per square inch (psi). All individual values and subranges from 125 to 275 are included; for example, the fluidized bed reactor can have an ethylene partial pressure from a lower limit of 125, 150, or 175 psi to an upper limit of 275, 250, or 225 psi.

One or more embodiments provide that ethylene is utilized as a monomer and hexene is utilized as a comonomer. The fluidized bed reactor can have a comonomer to ethylene mole ratio, e.g., C₆/C₂, from 0.002 to 0.100. All individual values and subranges from 0.002 to 0.100 are included; for example, the fluidized bed reactor can have a comonomer to ethylene mole ratio from a lower limit of 0.002, 0.003, or 0.004 to an upper limit of 0.100, 0.050, or 0.030.

The fluidized bed reactor can have a hydrogen to ethylene mole ratio (H₂/C₂) from 0.00001 to 0.00100. All individual values and subranges from 0.00001 to 0.00100 are included; for example, the fluidized bed reactor can have a H₂/C₂ from a lower limit of 0.00001, 0.00005, or 0.00008 to an upper limit of 0.00100, 0.00070, or 0.0.00050. One or more embodiments provide that a hydrogen feed to the fluidized bed reactor is not utilized; however, hydrogen may be generated in situ under polymerizable conditions for making the ethylene/1-hexene copolymers disclosed herein.

The fluidized bed reactor can have an isopentane mole percent from 1.0 to 15.0 percent. All individual values and subranges from 1.0 to 15.0 percent are included; for example, the fluidized bed reactor can have an isopentane mole percent from a lower limit of 1.0, 1.5, 2.0, or 2.5 percent to an upper limit of 15.0, 13.0, 10.0, or 7.0 percent.

The ethylene/1-hexene copolymer can have a density from 0.850 to 0.940 g/cm³. Density can be determined by according to ASTM D792-08, Method B. All individual values and subranges from 0.850 to 0.940 g/cm³ are included; for example, the polyolefin can have a density from a lower limit of 0.850, 0.870, 0.900, 0.902, 0.904, 0.906, or 0.908, g/cm³ to an upper limit of 0.940, 0.935, 0.930, 0.925, 0.923, or 0.920 g/cm³. One or more embodiments provide that the ethylene/1-hexene copolymer has a density from 0.850 to 0.935 g/cm³, or from 0.870 to 0.930 g/cm³.

The ethylene/1-hexene copolymer can have a melt index (I₂) from 0.01 to 5.0 dg/min. 12 can be determined by according to ASTM D1238-20 (190° C., 2.16 kg). All individual values and subranges from 0.01 to 5.0 dg/min are included; for example, the ethylene/1-hexene copolymer can have an 12 from a lower limit of 0.01, 0.07, or 0.13, 0.2, 0.3, 0.4, 0.5, dg/min to an upper limit of 5.0, 4.0, 3.0, 2.5, 2.0, 1.0 or 0.95 dg/min.

The ethylene/1-hexene copolymers disclosed herein can have a melt index (I₅) from 0.1 to 3.0 dg/min. 15 can be determined according to ASTM D1238-20 (190° C., 5 kg). All individual values and subranges from 0.1 to 3.0 dg/min are included; for example, the ethylene/1-hexene copolymer can have an 15 from a lower limit of 0.1, 0.2, or 0.3 dg/min to an upper limit of 3.0, 2.7, or 2.5 dg/min.

The ethylene/1-hexene copolymer can have a melt index (I₂₁) from 0.1 to 50 dg/min. 121 can be determined according to ASTM D1238-20 (190° C., 21.6 kg). All individual values and subranges from 0.1 to 50 dg/min are included; for example, the polyolefin can have an 121 from a lower limit of 0.1, 0.5, 1.0, 1,5, 2.0 or 2.5 dg/min to an upper limit of 50, 45, 40, 35, 30, 25, 20, 18, 15, 10, 7, or 5 dg/min. One or more embodiments provide that the ethylene/1-hexene copolymer has a melt index (I₂₁) from 1.0 to 10 dg/min, 1.5 to 7 dg/min, or 2.0 to 5 dg/min.

The ethylene/1-hexene copolymer can have an 121 to 12 ratio (I₂₁/I₂) less than or equal to 18.5. For instance, the polyolefin can have an 121/12 from a lower limit 8.0, 10.0, 13.0, or 15.0 to an upper limit of 18.5, 18.0, 17.7, or 17.5.

The ethylene/1-hexene copolymers disclosed herein can have an 121 to 15 ratio (I₂₁/I₅) from 3 to 10. All individual values and subranges from 3 to 10 are included; for example, the ethylene/1-hexene copolymer can have an 121/15 from a lower limit of 3, 4, or 5.5 to an upper limit of 10, 8, or 7.5.

The ethylene/1-hexene copolymers disclosed herein can have a weight average molecular weight (M_{w}(Abs)) from 65,000 to 250,000 g/mol. All individual values and subranges from 65,000 to 250,000 g/mol are included; for example, the ethylene/1-hexene copolymer can have an M_{w}(Abs) from a lower limit of 65,000, 85,000, or 100,000 g/mol to an upper limit of 250,000, 225,000, or 200,000 g/mol. M_{w}(Abs) can be determined by absolute gel permeation chromatography (GPC), as is known in the art. Absolute GPC is discussed herein. Alternatively, the ethylene/1-hexene copolymers disclosed herein can have a weight average molecular weight (M_{w}(Conv)) from 65,000 to 250,000 g/mol. All individual values and subranges from 65,000 to 250,000 g/mol are included; for example, the ethylene/1-hexene copolymer can have an M_{w}(Conv) from a lower limit of 65,000, 85,000, or 100,000 g/mol to an upper limit of 250,000, 225,000, or 200,000 g/mol. M_{w}(Conv) can be determined by conventional gel permeation chromatography (GPC), as is known in the art. Conventional GPC is discussed herein.

The ethylene/1-hexene copolymers disclosed herein can have a number average molecular weight (Mₙ(Abs)) from 20,000 to 85,000 g/mol. All individual values and subranges from 20,000 to 85,000 g/mol are included; for example, the ethylene/1-hexene copolymer can have an Mₙ(Abs) from a lower limit of 20,000, 25,000, or 30,000 g/mol to an upper limit of 85,000, 80,000, or 70,000 g/mol. Mₙ(Abs) can be determined by absolute gel permeation chromatography (GPC), as is known in the art. Absolute GPC is discussed herein. Alternatively, the ethylene/1-hexene copolymers disclosed herein can have a number average molecular weight (Mₙ(Conv)) from 20,000 to 85,000 g/mol. All individual values and subranges from 20,000 to 85,000 g/mol are included; for example, the ethylene/1-hexene copolymer can have an Mₙ(Conv) from a lower limit of 20,000, 25,000, or 30,000 g/mol to an upper limit of 85,000, 80,000, or 70,000 g/mol. Mₙ(Conv) can be determined by conventional gel permeation chromatography (GPC), as is known in the art. Conventional GPC is discussed herein.

The ethylene/1-hexene copolymers disclosed herein can have a Z-average molecular weight (M_{z}(Abs)) from 350,000 to 900,000 g/mol. All individual values and subranges from 350,000 to 900,000 g/mol are included; for example, the ethylene/1-hexene copolymer can have an M_{z}(Abs) from a lower limit of 350,000, 360,000, or 375,000 g/mol to an upper limit of 900,000, 800,000, or 750,000 g/mol. M_{z}(Abs) can be determined by absolute gel permeation chromatography (GPC), as is known in the art. Absolute GPC is discussed herein. Alternatively, the he ethylene/1-hexene copolymers disclosed herein can have a Z-average molecular weight (M_{z}(Conv)) from 350,000 to 900,000 g/mol. All individual values and subranges from 350,000 to 900,000 g/mol are included; for example, the ethylene/1-hexene copolymer can have an M_{z}(Conv) from a lower limit of 350,000, 360,000, or 375,000 g/mol to an upper limit of 900,000, 800,000, or 750,000 g/mol. M_{z}(Conv) can be determined by conventional gel permeation chromatography (GPC), as is known in the art. Conventional GPC is discussed herein.

The ethylene/1-hexene copolymers disclosed herein can have a weight average molecular weight to number average molecular weight ratio (Mw(Abs)/Mn(Abs)) from 2.0 to 3.5. All individual values and subranges from 2.0 to 3.5 are included; for example, the ethylene/1-hexene copolymer can have an Mw(Abs)/Mn(Abs) from a lower limit of 2.0, 2.1, 2.2, 2.3, 2.4, 2.5, or 2.6, or to an upper limit of 3.5, 3.4, 3.3, 3.2, 3.1, or 3.0. Alternatively, the ethylene/1-hexene copolymers disclosed herein can have a weight average molecular weight to number average molecular weight ratio (M_{w}(conv)/Mₙ(conv)) from 2.0 to 3.5. All individual values and subranges from 2.0 to 3.5 are included; for example, the ethylene/1-hexene copolymer can have an M_{w}(conv)/Mₙ(conv) from a lower limit of 2.0, 2.1, 2.2, 2.3, 2.4, 2.5, or 2.6, or to an upper limit of 3.5, 3.4, 3.3, 3.2, 3.1, or 3.0.

The ethylene/1-hexene copolymers disclosed herein can have a Z-average molecular weight to weight average molecular weight ratio (M_{z}(Abs)/M_{w}(Abs)) from 1.7 to 4.5. All individual values and subranges from 1.7 to 4.5 are included; for example, the ethylene/1-hexene copolymer can have an M_{z}(Abs)/M_{w}(Abs) from a lower limit of 1.7 to an upper limit of 4.5, 4.0, or 3.7. Alternatively, the ethylene/1-hexene copolymers disclosed herein can have a Z-average molecular weight to weight average molecular weight ratio (M_{z}(conv)/M_{w}(conv)) from 1.7 to 4.5. All individual values and subranges from 1.0 to 4.5 are included; for example, the ethylene/1-hexene copolymer can have an M_{z}(conv)/M_{w}(conv) from a lower limit of 1.7 to an upper limit of 4.5, 4.0, or 3.7.

The ethylene/1-hexene copolymers disclosed herein are made with a zirconocene catalyst and a hydrogenation catalyst.

Zirconocene catalysts are metallocenes that include zirconium. Metallocenes, e.g., zirconocenes, are known in the art. For instance, metallocene catalyst compounds include “half sandwich” and/or “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom. As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted. The Cp ligands are one or more rings or ring system(s), at least a portion of which includes π-bonded systems, such as cycloalkadienyl ligands and heterocyclic analogues. Embodiments of the present disclosure provide that the zirconocene catalyst can be made by a number of processes, e.g. with conventional solvents, reaction conditions, reaction times, and isolation procedures, utilized for making known metallocenes. Embodiments of the present disclosure provide that the zirconocene catalyst can be obtained commercially. For instance, one or more embodiments provide that the zirconocene catalyst is XCAT™ HP-100, available from Univation Technologies, LLC.

While not wishing to be bound to theory, hydrogenation catalysts may reduce the concentration of molecular hydrogen, which may be referred to as hydrogen herein, in a reaction system. Hydrogen can be intentionally added to a reaction system or generated by a metallocene catalyst during a polymerization process. Embodiments of the present disclosure provide that a titanocene catalyst may be utilized as the hydrogenation catalyst. Titanocene catalysts are metallocenes that include titanium.

Titanocene are catalysts are known in the art. Embodiments of the present disclosure provide that the titanocene catalyst can be made by a number of processes, e.g. with conventional solvents, reaction conditions, reaction times, and isolation procedures, utilized for making known metallocenes. Embodiments of the present disclosure provide that the titanocene catalyst system can be obtained commercially. Embodiments of the present disclosure provide that the titanocene catalyst system can be obtained through the combination of commercially available materials, for instance.

As is known in the art, an activator may be utilized. As used herein, “activator” refers to any compound or combination of compounds, supported, or unsupported, which can activate a complex or a catalyst component, such as by creating a cationic species of the catalyst component, e.g., to provide the catalyst. The activator may also be referred to as a “co-catalyst”. The activator can include a Lewis acid or a non-coordinating ionic activator or ionizing activator, or any other compound including Lewis bases, aluminum alkyls, and/or conventional-type co-catalysts. Activating conditions are well known in the art.

Embodiments provide that the titanium to zirconium molar ratio utilized may be from 0.100 to 0.700. All individual values and subranges from 0.100 to 0.700 are included; for example, the titanium to zirconium molar ratio can be from a lower limit of 0.100, 0.150, or 0.200 to an upper limit of 0.700, 0.600, or 0.500.

The ethylene/1-hexene copolymers disclosed herein have a cumulative detector fraction (CDF_{LS}) at a molecular weight (MW) of ≥1,000,000 g/mol of greater than 100*(0.0536−I₂₁*0.00224)%. This CDF_{LS} may indicate the high molecular species of the ethylene/1-hexene copolymer at given melt flow rate (I₂₁). CDF_{LS} can be determined via Low-Angle Laser Light Scattering (LALLS). CDF_{LS} can be determined as follows.

Gel permeation chromatography (GPC) Test Method for measuring molecular weights using a concentration-based detector (conventional GPC or “GPC_{conv}”): Use a PolymerChar GPC-IR (Valencia, Spain) high temperature GPC chromatograph equipped with an internal IR5 infra-red detector (IR5, measurement channel). Set temperatures of the autosampler oven compartment at 160° C. and column compartment at 150° C. Use a column set of four Agilent “Mixed A” 30 cm 20-micron linear mixed-bed columns; solvent is 1,2,4 trichlorobenzene (TCB) that contains 200 ppm of butylated hydroxytoluene (BHT) sparged with nitrogen. Injection volume is 200 microliters. Set flow rate to 1.0 milliliter/minute. Calibrate the column set with 21 narrow molecular weight distribution polystyrene (PS) standards (Agilent Technologies) with molecular weights ranging from 580 to 8,400,000. The PS standards were arranged in six “cocktail” mixtures with approximately a decade of separation between individual molecular weights in each vial. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. Convert the PS standard peak molecular weights (“MPS”) to polyethylene molecular weights (“MPE”) using the method described in Williams and Ward, J. Polym. Sci., Polym. Let., 6, 621 (1968) and equation 1: (M_{polyethylene}=A×(M_{polystyrene})B (EQ1), wherein M_{polyethylene} is molecular weight of polyethylene, M_{polystyrene} is molecular weight of polystyrene, A=0.4315, x indicates multiplication, and B=1.0. Dissolve samples at 2 mg/mL in TCB solvent at 160° C. for 2 hours under low-speed shaking. Generate a baseline-subtracted infra-red (IR) chromatogram at each equally-spaced data collection point (i), and obtain polyethylene equivalent molecular weight from a narrow standard calibration curve for each point (i) from EQ1.

The total plate count of the GPC column set was performed with decane without further dilution. The plate count (Equation 2) and symmetry (Equation 3) were measured on a 200 microliter injection according to the following equations.

$$Plate Count = 5.54 * {( \frac{( {RV}_{Peak Max}}{Peak Width at \frac{1}{2} height} )}^{2} . \qquad ( EQ2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - R {V}_{Peak max} )}{( R {V}_{Peak max} - Front Peak {RV}_{one tenth height} )} . \qquad Equation 3$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Calculate number-average molecular weight (referred to as Mₙ_{^{(GPC)}} or Mₙ(Conv)), weight-average molecular weight (referred to as M_{w}_{^{(GPC)}} or M_{w}(Conv)) and z-average molecular weight (referred to as M_{z}_{^{(GPC) or M}}_{z}(Conv)) based on GPC results using the internal IR5 detector (measurement channel) with PolymerChar GPCOne™ software and equations 4 to 6, respectively, the baseline-subtracted IR chromatogram at each equally-spaced data collection point (i), and the polyethylene equivalent molecular weight obtained from the narrow standard calibration curve for the point (i) from Equation 1.

$$\begin{matrix}Equation 4 & \\ {Mn}_{( GPC )} = \frac{{\sum }^{i} {IR}_{i}}{{\sum }^{i} ( {IR}_{i} / {M}_{{polyethylene}_{i}} )} . & ( EQ 4 )\end{matrix}$$

$$\begin{matrix}Equation 5 & \\ {Mw}_{( GPC )} = \frac{{\sum }^{i} ( {IR}_{i} * {M}_{{polyethylene}_{i}} )}{{\sum }^{i} {IR}_{i}} . & ( EQ 5 )\end{matrix}$$

$$\begin{matrix}Equation 6 & \\ {Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . & ( EQ 6 )\end{matrix}$$

Monitor effective flow rate over time using decane as a nominal flow rate marker during sample runs. Look for deviations from the nominal decane flow rate obtained during narrow standards calibration runs. If necessary, adjust the effective flow rate of decane so as to stay within ±2%, alternatively ±1%, of the nominal flow rate of decane as calculated according to equation 7: Flow rate(effective)=Flow rate(nominal)*(RV_{(FM Calculated)}/RV_{(FM Sample)} (EQ7), wherein Flow rate(effective) is the effective flow rate of decane, Flowrate(nominal) is the nominal flow rate of decane, RV_{(FM Calibrated)} is retention volume of flow rate marker decane calculated for column calibration run using narrow standards, RV_{(FM Sample)} is retention volume of flow rate marker decane calculated from sample run, * indicates mathematical multiplication, and/indicates mathematical division. Discard any molecular weight data from a sample run with a decane flow rate deviation more than ±2%, alternatively ±1%.

Gel Permeation Chromatography Test Method for measuring absolute molecular weight measurements (absolute GPC or “GPC_{abs}”) using the PolymerChar GPC-IR high temperature GPC chromatograph equipped with the internal IR5 infra-red detector (IR5), wherein the IR5 detector is coupled to a Precision Detectors (Now Agilent Technologies) 2-angle laser light scattering (LS) detector Model 2040. For all Light scattering measurements, the 15 degree angle is used for measurement purposes.

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chapter 12, (1992)) (Balke, Thitiratsakul, Lew, Cheung, Mourey, Chromatography Polym. Chapter 13, (1992)), optimizing triple detector log (MW and IV) results from a broad homopolymer polyethylene standard (M_{w}/Mₙ>3) to the narrow standard column calibration results from the narrow standards calibration curve using PolymerChar GPCOne™ Software.

The absolute molecular weight data are obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

Absolute weight-average molecular weight (MW_{(Abs)}) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™).

Absolute number-average molecular weight (Mn_{(Abs)}) and absolute z-average molecular weight (Mz_{(Abs)}) are calculated according to equations 8-9 as follows:

$${Mn}_{( Ab s )} = \frac{{\sum }^{i} {IR}_{i}}{{\sum }^{i} ( {IR}_{i} / {M}_{{Absolute}_{i}} )} . \qquad ( EQ 8 )$$

$${Mz}_{( Ab s )} = \frac{{\sum }^{i} ( {IR}_{i} * {M}_{{Absolute}_{i}}^{2} )}{{\sum }^{i} ( {IR}_{i} * {M}_{{Absolute}_{i}} )} . \qquad ( EQ 9 )$$

Calculation of the cumulative detector fractions (CDF) for the low angle laser light scattering detector (“CDF_{LS}”) can accomplished as follows. 1) Linearly flow correct the chromatogram based on the relative retention volume ratio of the air peak between the sample and that of a consistent narrow standards cocktail mixture. 2) Correct the light scattering detector offset (effective offset) relative to the IR5 as previously described. 3) Calculate the molecular weights at each retention volume (RV) data slice based on the polystyrene calibration curve, modified by the polystyrene to polyethylene conversion factor of approximately (0.395-0.440) as previously described. 4) Subtract baselines from the light scattering and IR5 chromatograms and set integration windows using standard GPC practices making certain to integrate all of the low molecular weight retention volume range in the light scattering chromatogram that is observable from the IR5 chromatogram (thus setting the highest RV limit to the same index in each chromatogram). Do not include any material in the integration which corresponds to less than 150 Dalton in either chromatogram. 5) Calculate the cumulative detector fraction (CDF_{LS}) of the Low-Angle Laser Light Scattering (LALLS) chromatogram (CDF_{LS}) based on its baseline-subtracted peak height (H) from high to low molecular weight (low to high retention volume) at each data slice (j) according to the following equation:

$$C D {F}_{L S \geq 1 , 000 , 000 MW} = \frac{{\sum }_{j = RV at Lowest Integrated Volume}^{j = RV at 1 , 000 , 000 MW} Hj}{{\sum }_{j = RV at Lowest Integrated Volume}^{j = RV at Highest Integrated Volume} Hj} \qquad Equation 10$$

As shown in the Examples section, each of Examples 1-3 desirably had a CDF_{LS} greater than 100*(0.0536−I₂₁*0.00224) %, in contrast to each of Comparative Examples A-C, which each had a CDF_{LS} less than 100*(0.0536−I₂₁*0.00224) %. This improved CDF_{LS} indicates an improved high molecular weight fraction at a given melt flow rate I₂₁, which is desirable for a number of applications.

The ethylene/1-hexene copolymers disclosed herein can have an absolute weight average molecular weight (M_{w}(Abs)) from 90,000 to 300,000 g/mol. All individual values and subranges from 90,000 to 300,000 g/mol are included; for example, the ethylene/1-hexene copolymer can have an M_{w}(Abs) from a lower limit of 90,000, 95,000, or 100,000 g/mol to an upper limit of 300,000, 250,000, or 200,000 g/mol. M_{w}(Abs) can be determined by absolute gel permeation chromatography (GPC), as is known in the art. Absolute GPC is discussed herein.

The ethylene/1-hexene copolymers disclosed herein can have an absolute number average molecular weight (Mₙ(Abs)) from 20,000 to 130,000 g/mol. All individual values and subranges from 20,000 to 130,000 g/mol are included; for example, the ethylene/1-hexene copolymer can have an Mₙ(Abs) from a lower limit of 20,000, 25,000, or 30,000 g/mol to an upper limit of 130,000, 100,000, or 85,000 g/mol. Mₙ(Abs) can be determined by absolute gel permeation chromatography (GPC), as is known in the art. Absolute GPC is discussed herein.

The ethylene/1-hexene copolymers disclosed herein can have an absolute Z-average molecular weight (M_{z}(Abs)) from 125,000 to 1,000,000 g/mol. All individual values and subranges from 125,000 to 1,000,000 g/mol are included; for example, the ethylene/1-hexene copolymer can have an M_{z}(Abs) from a lower limit of 125,000, 150,000, or 200,000 g/mol to an upper limit of 1,000,000, 850,000, or 700,000 g/mol. M_{z}(Abs) can be determined by absolute gel permeation chromatography (GPC), as is known in the art. Absolute GPC is discussed herein.

A method for comonomer content analysis (iCCD) has been previously disclosed (Cong and Parrott et al., see publication WO 2017040127A1) may be utilized. The iCCD test can be performed with Crystallization Elution Fractionation instrumentation (CEF) (PolymerChar, Spain) equipped with IR-5 detector (PolymerChar, Spain) and two angle light scattering detector Model 2040 (Precision Detectors, currently Agilent Technologies). A guard column packed can be with 20-27-micron glass (MoSCi Corporation, USA) in a 5 cm or 10 cm (length)×¼″ (ID) stainless cylinder installed just before the IR-5 detector in the detector oven. Ortho-dichlorobenzene (ODCB, 99% anhydrous grade or technical grade) can be used as solvent. Silica gel 40 (particle size 0.2-0.5 mm, catalogue number 10181-3) from EMD Chemicals can be used to dry the ODCB solvent before. Dried silica can be packed into three emptied HT-GPC columns to further purify ODCB as eluent. The CEF instrument can be equipped with an autosampler with N₂ purging capability. ODCB can be sparged with dried nitrogen (N₂) for one hour before use. Sample preparation can be done with autosampler at 4 mg/ml (unless otherwise specified) under shaking at 160° C. for 1 hour. The injection volume can be 300 μl. The temperature profile of iCCD can be: crystallization at 3° C./min from 105° C. to 30° C., the thermal equilibrium at 30° C. for 2 minute (including Soluble Fraction Elution Time being set as 2 minutes), elution at 3° C./min from 30° C. to 140° C. The flow rate during crystallization can be 0.0 mL/min. The flow rate during elution can be 0.50 mL/min. The data can be collected at one data point/second.

The iCCD column can be packed with gold coated nickel particles (Bright 7GNM8-NiS, Nippon Chemical Industrial Co.) in a 15 cm (length)×¼″ (ID) stainless tubing. The column packing and conditioning can be with a slurry method, e.g. see publication Cong, R.; Parrott, A.; Hollis, C.; Cheatham, WO 2017040127A1. The final pressure with TCB slurry packing can be 150 Bars.

Column temperature calibration can be performed by using a mixture of the Reference Material Linear homopolymer polyethylene (having zero comonomer content, Melt index (I₂) of 1.0 g/cm³, polydispersity M_{w}(conv)/Mₙ(conv) approximately 2.6 by conventional gel permeation chromatography at a concentration of 1.0 mg/mL) and Eicosane (2 mg/mL) in ODCB. iCCD temperature calibration can include four steps: (1) Calculating the delay volume defined as the temperature offset between the measured peak elution temperature of Eicosane minus 30.00° C.; (2) Subtracting the temperature offset of the elution temperature from iCCD raw temperature data. It is noted that this temperature offset is a function of experimental conditions, such as elution temperature, elution flow rate, etc.; (3) Creating a linear calibration line transforming the elution temperature across a range of 30.00° C. and 140.00° C. so that the linear homopolymer polyethylene reference had a peak temperature at 101.0° C., and Eicosane had a peak temperature of 30.0° C.; (4) For the soluble fraction measured isothermally at 30° C., the elution temperature below 30.0° C. is extrapolated linearly by using the elution heating rate of 3° C./min, e.g., according to Cerk and Cong et al., see U.S. Pat. No. 9,688,795.

The comonomer content versus elution temperature of iCCD can be constructed by using 12 reference materials (ethylene homopolymer and ethylene-octene random copolymer made with single site metallocene catalyst, having ethylene equivalent weight average molecular weight ranging from 35,000 to 128,000). All of these reference materials can be analyzed same way as specified previously at 4 mg/mL. The reported elution peak temperatures followed octene mole % versus elution temperature of iCCD at R² of 0.978, where y=−6.315×/101.0000.

The ethylene/1-hexene copolymers disclosed herein high density fraction (HDF) can be calculated as an integral from the iCCD curve from 93° C. to 119° C. This is defined as the integral of the IR-4 chromatogram (baseline subtracted measurement channel) in the elution temperature ranging from 93° C. to 119° C. divided by the total integral from 20° C. to 140° C. according to the following equation, where T is the elution temperature (from the calibration discussed above):

$$H D F = \frac{{\int }_{93.}^{119.} IRdT}{{\int }_{20.}^{140.} IRdT} * 100 \%$$

The zero-shear viscosity (ZSV) value of the polyethylene material (η₀) in be obtained via the method described below. Rheological properties can be determined from 0.1 to 100 radians/second (rad/s) in a nitrogen environment at 190° C. and a strain amplitude of 10% in an ARES-G2 Advanced Rheometric Expansion System (TA Instrument) rheometer oven that is preheated for at least 30 minutes at 190° C. The disk, prepared by the Compression Molded Plaque Preparation Method, can be placed between two “25 mm” parallel plates in the oven. The gap can be slowly reduced between the “25 mm” parallel plates to 2.0 mm. The sample can remain for 5 minutes at these conditions. Then, the oven can be opened, and excess sample from around the edge of the plates can be trimmed. The oven can be closed and an additional five-minute delay can be used to allow for temperature equilibrium. Then, the complex shear viscosity can be determined via a small amplitude, oscillatory shear, according to an increasing frequency sweep from 0.1 to 100 rad/s to obtain the complex viscosities at 0.1 rad/s and 100 rad/s. The zero-shear viscosity (ZSV) value can be defined by TA instruments TRIOS software, which was estimated according to the Carreau-Yasuda model.

Composition distribution breadth index (CDBI) is defined as the weight percent of the ethylene/1-hexene copolymers molecules having a comonomer content within 50 percent of the median total molar comonomer content. For instance, if the median total molar comonomer content of a certain group of polyolefin molecules is found to be 4 mole percent, the CDBI of that group of i polyolefin molecules would be the weight percent of polyolefin molecules having a molar comonomer concentration from 2 to 6 mole percent. If 55 wt % of the polyolefin molecules had a molar comonomer content in the 2 to 6 mole percent range, the CDBI would be 55%. The CDBI of linear homopolymer polyethylene, which does not contain a comonomer, is defined to be 100%. The CDBI of a copolymer is readily calculated by data obtained from techniques well known in the art, such as, for example, temperature rising elution fractionation as described, for example, in U.S. Pat. No. 5,008,204 or in Wild et al., J. Polv. Sci, Polv. Phvs. Ed., vol. 20, p. 441 (1982).

Melt strength can be determined by a Melt Strength Measurement process, as described as follows.

The melt Strength (MS) measurements were conducted on a Gottfert Rheotens 71.97 (Gottfert Inc.; Rock Hill, S.C.) attached to a Gottfert Rheotester 2000 or Rheograph 25 capillary rheometer. A polymer melt (about 20-30 grams, pellets) was extruded through a capillary die with a flat entrance angle (180 degrees) with a capillary diameter of 2.0 mm and an aspect ratio (capillary length/capillary diameter) of 15. After equilibrating the samples at 190° C. for 10 minutes, the piston was run at a constant speed to achieve an apparent wall shear rate of 38.16 s⁻¹. The standard test temperature was 190° C. The sample was drawn uniaxially to a set of accelerating nips located 100 mm below the die, with an acceleration of 2.4 mm/s². Note that the spacing between these wheels are 0.4 mm. The tensile force was recorded as a function of the take-up speed of the nip rolls. Melt strength was reported as the plateau force (cN) before the strand broke. The following conditions were used in the melt strength measurements: apparent wall sear rate=38.16 s⁻¹; wheel acceleration=2.4 mm/s²; capillary diameter=2.0 mm; and capillary length=30 mm.

The ethylene/1-hexene copolymers disclosed herein can have a melt strength (190° C.), as determined by the Melt Strength Measurement process described herein, from 7 to 15 centinewtons (cN). All individual values and subranges from 7 to 15 cN are included; for example, the ethylene/1-hexene copolymer can have a melt strength from a lower limit of 7, 8, or 9 cN to an upper limit of 15, 13, or 11 cN.

The ethylene/1-hexene copolymers disclosed herein can have a high density fraction (93-119° C.) from 5% to 30%. All individual values and subranges from 5% to 30% are included; for example, the ethylene/1-hexene copolymer can have a high density fraction (93-119° C.) from a lower limit of 5, 8, or 10% to an upper limit of 30, 28, or 25%. High density fraction (93-119° C.) may be determined as discussed herein, i.e., calculated as an integral from an iCCD curve from 93° C. to 119° C.

The ethylene/1-hexene copolymers disclosed herein can have a short chain branching distribution (SCBD) from 10 to 50 determined using iCCD. All individual values and subranges from 10 to 50 are included; for example, the ethylene/1-hexene copolymer can have a SCBD from a lower limit of 10, 12, or 15 to an upper limit of 50, 45, or 40. SCBD may be determined from data obtained from techniques known in the art, such as, for example, temperature rising elution fractionation (abbreviated herein as “TREF”) as described, for example, by Wild et al., Journal of Polymer Science, Poly. Phys. Ed., Vol. 20, p. 441 (1982), or in U.S. Pat. Nos. 4,798,081; 5,008,204; or by L. D. Cady, “The Role of Comonomer Type and Distribution in LLDPE Product Performance,” SPE Regional Technical Conference, Quaker Square Hilton, Akron, Ohio, October 1-2, pp. 107-119 (1985).

The ethylene/1-hexene copolymers disclosed herein can have a composition distribution breadth index (CDBI) from 35 to 80. All individual values and subranges from 35 to 80 are included; for example, the ethylene/1-hexene copolymer can have a CDBI from a lower limit of 35, 45, or 55 to an upper limit of 80, 75, or 70. CDBI may be determined from data obtained from techniques known in the art, such as, for example, temperature rising elution fractionation (abbreviated herein as “TREF”) as described, for example, by Wild et al., Journal of Polymer Science, Poly. Phys. Ed., Vol. 20, p. 441 (1982), or in U.S. Pat. Nos. 4,798,081; 5,008,204; or by L. D. Cady, “The Role of Comonomer Type and Distribution in LLDPE Product Performance,” SPE Regional Technical Conference, Quaker Square Hilton, Akron, Ohio, October 1-2, pp. 107-119 (1985).

The ethylene/1-hexene copolymers disclosed herein can have an Instrumented Dart Impact (IDI) Total Energy from 4.0 to 25.0 J; for instance, for a film having a 2 mil thickness and made as discussed herein All individual values and subranges from 4.0 to 25.0 J are included; for example, the ethylene/1-hexene copolymer can have an Instrumented Dart Impact (IDI) Total Energy from a lower limit of 4.0, 4.5, or 5.0 J to an upper limit of 25.0, 20.0, or 18.0 J. Instrumented Dart Impact (IDI) Total Energy can be determined according to ASTM D3763-18.

The ethylene/1-hexene copolymers disclosed herein can have an Instrumented Dart Impact (IDI) Peak Force greater than 315 Newtons (N). For instance, the ethylene/1-hexene copolymers disclosed herein can have an Instrumented Dart Impact (IDI) Peak Force from 315 to 450 N. All individual values and subranges from 315 to 450 N are included; for example, the ethylene/1-hexene copolymer can have an Instrumented Dart Impact (IDI) Peak Force from a lower limit of 315, 320, 323, or 325 N to an upper limit of 450, 400, 375, or 350 N. Instrumented Dart Impact (IDI) Peak Force can be determined according to ASTM D3763-18. This Instrumented Dart Impact (IDI) Peak Force indicates an increased toughness associated with the inventive samples at a given density and/or 121, for instance.

Embodiments provide that the ethylene/1-hexene copolymers that provide a desirable Instrumented Dart Impact (IDI) Peak Force of greater than 315 Newtons have a cumulative detector fraction (CDF_{LS}) at a molecular weight of ≥1,000,000 g/mol of greater than 4%. For instance, the ethylene/1-hexene copolymers can have a cumulative detector fraction (CDF_{LS}) at a molecular weight of ≥1,000,000 g/mol of 4% to 12%. All individual values and subranges from 4% to 12%. are included; for example, the ethylene/1-hexene copolymer can have a cumulative detector fraction (CDF_{LS}) at a molecular weight of ≥1,000,000 g/mol from a lower limit of 4, 4.5 or 5% to an upper limit of 12, 10, or 8%. CDF_{LS} can be determined as discussed herein.

The ethylene/1-hexene copolymers disclosed herein can be utilized to provide a film dart impact from 700 to 1200 grams. All individual values and subranges from 700 to 1200 grams are included; for example, the ethylene/1-hexene copolymer can be utilized to provide a film dart impact from a lower limit of 700, 800, or 900 grams to an upper limit of 1200, 1100, or 1000 grams. Film dart can be determined according to ASTM D1709-16, Method A.

The ethylene/1-hexene copolymers disclosed herein may be utilized for a number of applications including, but not limited to, molded articles, extruded articles, films, fibers, nonwoven fabrics and/or woven fabrics. The ethylene/1-hexene copolymers disclosed herein may be utilized for molding applications, e.g., in making bottles, tanks, hollow articles, rigid food containers, and toys, among other molded articles.

One or more embodiments provide a method for increasing Instrumented Dart Impact (IDI) Peak Force. The method includes contacting a zirconocene catalyst and a hydrogenation catalyst with ethylene and hexene in a gas-phase reactor under polymerizable conditions, wherein the zirconocene catalyst and the hydrogenation catalyst have a titanium to zirconium molar ratio from 0.100 to 0.700 and making a ethylene/1-hexene copolymer having a density from 0.850 to 0.940 g/cm³ and an Instrumented Dart Impact (IDI) Peak Force greater than 315 Newtons and a cumulative detector fraction (CDFLS) at a molecular weight of >1,000,000 g/mol of greater than 4%. Additionally, the ethylene/1-hexene copolymer can have a melt strength from 7 to 15 cN.

Embodiments provide the Instrumented Dart Impact (IDI) Peak Force and/or Instrumented Dart Impact (IDI) Peak Energy is increased as compared to a different ethylene/1-hexene copolymer made with a gas-phase reactor under similar, e.g., the same, polymerizable conditions with the proviso that the hydrogenation catalyst is not utilized to make the different ethylene/1-hexene copolymer.

One or more embodiments provide that the ethylene/1-hexene copolymers, made by the methods described herein, have a melt strength from 7 to 15 cN, as determined by the previously mentioned Melt Strength Measurement process. Embodiments provide the melt strength from 7 to 15 cN is increased as compared to a different ethylene/1-hexene copolymer made with a gas-phase reactor under similar, e.g., the same, polymerizable conditions with the proviso that the hydrogenation catalyst is not utilized to make the different ethylene/1-hexene copolymer.

Embodiments provide the ethylene/1-hexene copolymer having the improved IDI Peak Force and/or melt strength and the different ethylene/1-hexene copolymer have a similar density, e.g. the densities are ±0.01 or ±0.005 of one another.

One or more embodiments provide that the ethylene/1-hexene copolymers disclosed herein can be referred to as “virgin raw polymer”. “Virgin raw polymer” refers to polymers that can be characterized as “primary (virgin) raw material,” as defined by ISO 18604. The term virgin raw polymer thus includes polymers that have never been processed into any form of end-use product. Virgin raw polymer may also be referred to as “primary raw polymer”, among other terms.

One or more embodiments provide that the ethylene/1-hexene copolymers disclosed herein are utilized with a recycled polyethylene, e.g., the ethylene/1-hexene copolymer and the recycled polyethylene can be combined. For instance, the ethylene/1-hexene copolymer and the recycled polyethylene can be combined to make a thermoplastic composition.

The term “recycled polyethylene” refers to polymers, e.g., polyethylenes, recovered from post-consumer material as defined by ISO 14021, polymers recovered from pre-consumer material as defined by ISO 14021, and combinations thereof. The generic term post-consumer recycled polyethylene thus includes blends of polymers recovered from materials generated by households or by commercial, industrial, and institutional facilities in their role as end-users of the material, which can no longer be used for its intended purpose. The generic term post-consumer recycled polyethylene also includes blends of polymers recovered from returns of materials from the distribution chain. The generic term pre-consumer recycled polyethylene thus includes blends of polymers recovered from materials diverted from the waste stream during a manufacturing process. The generic term pre-consumer recycled polyethylene excludes the reutilization of materials, such as rework, regrind, or scrap, generated in a process and capable of being reclaimed within the same process that generated it. The recycled polyethylene may include polyethylene or a blend of polyethylene recovered from post-consumer material, pre-consumer material, or combinations thereof. The terms “pre-consumer recycled polymer” and “post-industrial recycled polymer” may be utilized to refer to “recycled polyethylene”.

The recycled polyethylene may include one or more contaminants. The contaminants may be the result of the polymeric material's use prior to being repurposed for reuse. For example, contaminants may include paper, ink, food residue, or other recycled materials in addition to the polymer, which may result from a recycling process. PCR, e.g., recycled polyethylene, is distinct from virgin polymeric material. A virgin polymeric material, e.g., “virgin raw polymer” as previously mentioned, does not include materials previously used in a consumer or industry application. Virgin polymeric material has not undergone, or otherwise has not been subject to, a heat process or a molding process, after the initial polymer manufacturing process. The physical, chemical, and flow properties of PCR resins differ when compared to virgin polymeric resin, which in turn can present challenges to incorporating PCR into formulations for commercial use.

The PCR, e.g., recycled polyethylene, can include various compositions. PCR may be sourced from HDPE packaging such as bottles (milk jugs, juice containers), LDPE/LLDPE packaging such as films. PCR also includes residue from its original use, residue such as paper, adhesive, ink, nylon, ethylene vinyl alcohol (EVOH), polyethylene terephthalate (PET), and other odor-causing agents. Sources of PCR resin can include, for example, bottle caps and closures, milk, water or orange juice containers, detergent bottles, office automation equipment (printers, computers, copiers, etc.), white goods (refrigerators, washing machines, etc.), consumer electronics (televisions, video cassette recorders, stereos, etc.), automotive shredder residue (the mixed materials remaining after most of the metals have been sorted from shredded automobiles and other metal-rich products “shredded” by metal recyclers), packaging waste, household waste, rotomolded parts (kayaks/coolers), building waste and industrial molding and extrusion scrap.

In one or more embodiments, the PCR resin can comprise low density polyethylene, linear low-density polyethylene, or a combination thereof. In embodiments, the PCR can further comprise residue from its original use, such as paper, adhesive, ink, nylon, ethylene vinyl alcohol (EVOH), polyamide (PA), polyethylene terephthalate (PET), and other organic or inorganic material. Recycled polyethylenes are commercially available. Examples of PCR include AVANGARD NATURA PCR-LDPCR-100 (“AVANGARD 100”) and AVANGARD NATURA PCR-LDPCR-150 (“AVANGARD 150”) (commercially available from Avangard Innovative LP, Houston, Texas). Another example of commercially available recycled polyethylene is NATURA LDPE PCR 100, from Avangard Innovative LP.

In one or more embodiments, the recycled polyethylene may have a density from 0.900 to 0.940 g/cm³. All individual values and subranges of from 0.900 to 0.940 g/cm³ are disclosed and incorporated herein; for example the recycled polyethylene may have a density from a lower limit of 0.900, 0.905, or 0.910 to an upper limit of 0.940, 0.935, 0.930, or 0.925 g/cm³. In one or more embodiments, the recycled polyethylene may have a melt index (12) from 0.30 dg/min to 6.00 dg/min. All individual values and subranges of from 0.30 dg/min to 6.00 dg/min are disclosed and incorporated herein; for example the recycled polyethylene may have a melt index (12) from a lower limit 0.30, 0.80, 1.00, 1.25, 1.50, or 1.80 dg/min to an upper limit of 6.00, 5.00, 4.00, 3.50, 3.00, or 2.80 dg/min. In one or more embodiments, the recycled polyethylene, may have a melting point (Tₘ) greater than or equal to 105° C., such as greater than or equal to 110° C., greater than or equal to 115° C., greater than or equal to 120° C., greater than or equal to 125° C., or greater than or equal to 130° C. The recycled polyethylene may also have a melting point (Tₘ) less than or equal to 135° C., such as less than or equal to 130° C., less than or equal to 125° C., less than or equal to 120° C., less than or equal to 115° C., or less than or equal to 110° C. For example, the post-consumer recycled polyethylene may also have a melting point (Tₘ) of from 105° C. to 135° C., from 105° C. to 130° C., from 105° C. to 125° C., from 105° C. to 120° C., from 105° C. to 115° C., from 105° C. to 110° C., from 110° C. to 135° C., from 110° C. to 130° C., from 110° C. to 125° C., from 110° C. to 120° C., from 110° C. to 115° C., from 115° C. to 135° C., from 115° C. to 130° C., from 115° C. to 125° C., from 115° C. to 120° C., from 120° C. to 135° C., from 120° C. to 130° C., from 120° C. to 125° C., from 125° C. to 135° C., from 125° C. to 130° C., or from 130° C. to 135° C.

Embodiments provide that the recycled polyethylene can be from 0.5 wt % to 85.0 wt % of the thermoplastic composition based upon a total weight of the ethylene/1-hexene copolymer and the recycled polyethylene. In other words, the ethylene/1-hexene copolymer can be from 99.5 wt % to 15 wt % of the thermoplastic composition based upon a total weight of the ethylene/1-hexene copolymer and the recycled polyethylene. One or more embodiments provide that the thermoplastic composition includes the ethylene/1-hexene copolymer in an amount of from 20 wt. % to 75 wt. % based on a total weight of the ethylene/1-hexene copolymer and the recycled polyethylene. One or more embodiments provide that the thermoplastic composition includes the ethylene/1-hexene copolymer in an amount of 30 wt. % based on a total weight of the ethylene/1-hexene copolymer and the recycled polyethylene. One or more embodiments provide that the thermoplastic composition includes the ethylene/1-hexene copolymer in an amount of 50 wt. % based on a total weight of the ethylene/1-hexene copolymer and the recycled polyethylene. One or more embodiments provide that the thermoplastic composition includes the ethylene/1-hexene copolymer in an amount of 75 wt. % based on a total weight of the ethylene/1-hexene copolymer and the recycled polyethylene.

A number of aspects of the present disclosure are provided as follows.

Aspect 1 provides an ethylene/1-hexene copolymer, wherein the ethylene/1-hexene copolymer has a density from 0.850 to 0.940 g/cm³, a melt index (I₂₁) from 0.1 to 50 dg/min, a melt index (I₂₁/I₂) ratio less than or equal to 18.5, a M_{w}(Abs)/Mₙ(Abs) from 2.0 to 3.5, a M_{z}(Abs)/M_{w}(Abs) from 1.7 to 4.5, and a cumulative detector fraction (CDF_{LS}) at a molecular weight of ≥1,000,000 g/mol of greater than 100*(0.0536−I₂₁*0.00224)%.

In some embodiments, the ethylene/1-hexene copolymer of Aspect 1 also has at least one, alternatively each of properties (a) and (b): (a) a ratio of M_{w}(Conv)/Mₙ(Conv) from 2.0 to 3.5, wherein M_{w}(Conv) is weight-average molecular weight and Mₙ(Conv) is number-average molecular weight, both measured by Gel Permeation Chromatography (GPC) Test Method 1 (GPC(conv)); (b) a ratio of M_{z}(Conv)/M_{w}(Conv) from 1.7 to 4.5, wherein M_{z}(Conv) is Z-average molecular weight and M_{w}(Conv) is weight-average molecular weight, both measured by Gel Permeation Chromatography (GPC) Test Method 1 (GPC(conv)).

Aspect 2 provides the ethylene/1-hexene copolymer of Aspect 1, wherein the density is from 0.870 to 0.930 g/cm³ and the melt index (I₂₁) is from 1.0 to 10 dg/min and the ethylene/1-hexene copolymer has a M_{z}(conv) from 350,000 to 900,000 g/mol, a high density fraction (93-119° C.) from 5% to 30%, a short chain branching distribution from 10 to 50, and a composition distribution breadth index from 35 to 80.

In some embodiments, the ethylene/1-hexene copolymer of aspect 2 also has a M_{z}(Conv) from 350,000 to 900,000 g/mol.

Aspect 3 provides the ethylene/1-hexene copolymer of Aspect 1 or Aspect 2, wherein the ethylene/1-hexene copolymer has an Instrumented Dart Impact (IDI) Peak Force greater than 315 Newtons and a cumulative detector fraction (CDF_{LS}) at a molecular weight of ≥1,000,000 g/mol of greater than 4%.

Aspect 4 provides an ethylene/1-hexene copolymer, wherein the ethylene/1-hexene copolymer has a density from 0.850 to 0.940 g/cm³, a melt index (I₂₁) from 0.1 to 10 dg/min, an Instrumented Dart Impact (IDI) Peak Force greater than 315 Newtons, and a cumulative detector fraction (CDF_{LS}) at a molecular weight of ≥1,000,000 g/mol of greater than 4%.

Aspect 5 provides the ethylene/1-hexene copolymer of Aspect 4, wherein the ethylene/1-hexene copolymer has a melt strength from 7 to 15 cN.

Aspect 6 provides the ethylene/1-hexene copolymer of Aspect 4 or Aspect 5, wherein the ethylene/1-hexene copolymer has a cumulative detector fraction (CDF_{LS}) at a molecular weight of ≥1,000,000 g/mol of greater than 100*(0.0536−I₂₁*0.00224)%.

Aspect 7 provides A thermoplastic composition comprising from 0.5 wt % to 75.0 wt % of a recycled polyethylene and from 25.0 wt % to 99.5 wt % of the ethylene/1-hexene copolymer of any one of Aspects 1 to 6 (e.g., the ethylene/1-hexene copolymer of any one of Aspects 1 to 3 or the ethylene/1-hexene copolymer of any one of Aspects 4 to 6); wherein at least 90.0 wt % of the thermoplastic composition is comprised of the recycled polyethylene and the ethylene/1-hexene copolymer; wherein the recycled polyethylene comprises either a first blend of polyethylenes recovered from post-consumer material, a second blend of polyethylenes recovered from pre-consumer material, or a combination of the first and second blends; and wherein the recycled polyethylene has: a density of from 0.900 g/cm³ to 0.940 g/cm³ when measured according to ASTM D792-08, Method B; a melt index (I₂) of from 0.30 dg/min to 6.00 dg/min when measured according to ASTM D1238-10, Method B, at 190° C. and a 2.16 kg load.

Aspect 8 provides a method for increasing Instrumented Dart Impact (IDI) Peak Force, the method comprising:
contacting a zirconocene catalyst and a hydrogenation catalyst with ethylene and 1-hexene in a gas-phase reactor under polymerizable conditions, wherein the zirconocene catalyst and the hydrogenation catalyst have a titanium to zirconium molar ratio from 0.100 to 0.700; and making an ethylene/1-hexene copolymer having a density from 0.850 to 0.940 g/cm³ and an Instrumented Dart Impact (IDI) Peak Force greater than 315 Newtons and a cumulative detector fraction (CDF_{LS}) at a molecular weight of ≥1,000,000 g/mol of greater than 4%.

Aspect 9 provides the method of Aspect 8, wherein the ethylene/1-hexene copolymer has a melt strength from 7 to 15 cN.

Aspect 10 provides the method of Aspect 8 or Aspect 9 wherein the ethylene/1-hexene copolymer is the ethylene/1-hexene copolymer of any one of Aspects 1 to 3 or the ethylene/1-hexene copolymer of any one of Aspects 4 to 6.

### EXAMPLES

For the Examples, XCAT™ HP-100 (zirconocene catalyst, obtained from Univation Technologies, LLC) was utilized.

Hydrogenation catalyst-1 (titanocene catalyst) was prepared as follows: a 1 L bottle was charged with 15.1 g of bis(cyclopentadienyl)titanium dichloride (Sigma-Aldrich), 527 mL of hexane, and a stir bar to form a suspended mixture. To this mixture, 60.3 g of triisobutylaluminum (neat, Sigma-Aldrich) was slowly add over 10 minutes while stirring. The solid Cp₂TiCl₂ became soluble and formed a blue solution which was further diluted with isopentane to provide a 0.3 weight percent mixture.

Example 1, an ethylene/1-hexene copolymer, was made utilizing XCAT™ HP-100 and hydrogenation catalyst-1 as follows. XCAT™ HP-100 and hydrogenation catalyst-1 were separately fed into a gas-phase reactor to make a zirconocene/titanocene catalyst system in situ; the XCAT™ HP-100 was fed dry using nitrogen as carrier, and hydrogenation catalyst-1 was fed as liquid catalyst solution in isopentane. Then, ethylene was copolymerized with 1-hexene in the gas-phase reactor. The polymerization was continuously conducted after equilibrium was reached under conditions set forth in Table I.

Example 2-3, ethylene/1-hexene copolymers, were made as Example 1 with any changes indicated in Tables 2-3.

Comparative Examples A-C were made as Example 1; however, hydrogenation catalyst-1 was not utilized for Comparative Examples A-C. Changes to Example 1, for Comparative Examples A-C, are indicated in Tables 1-3.

TABLE 1

| | Comparative |
|---|---|
| Example | Example |
| 1 | A |

Conditions for gas-phase reactor

| | | |
|---|---|---|
| Reactor | 85 | 85 |
| Temperature | | |
| (° C.) | | |
| Reactor | 378 | 378 |
| Pressure | | |
| (psig) | | |
| C₂ partial | 200 | 200 |
| pressure | | |
| (psi) | | |
| H₂ to C₂ ratio | 0.000069 | 0.00012 |
| (mol/mol) | | |
| C₆ to C₂ ratio | 0.017 | 0.022 |
| (mol/mol) | | |
| Isopentane | 4.99 | 4.94 |
| (mol %) | | |
| C₂ feed rate | 40.7 | 35.5 |
| (lb/hr) | | |
| C₆ feed rate | 1.949 | 2.129 |
| (lb/hr) | | |
| H₂ feed rate | — | — |
| (millipound/hr) | | |
| Reactor vent | 14.8 | 16.4 |
| (lb/hr) | | |
| Zr feed rate | 0.027 | 0.014 |
| (from | | |
| zirconocene | | |
| g/hr) | | |
| Titanocene | 107.7 | — |
| solution feed | | |
| rate | | |
| (cm³/hr) | | |
| Titanium to | 0.445 | — |
| zirconium | | |
| (molar ratio) | | |
| Production rate | 34.3 | 30.3 |
| (lb/hr) | | |
| Bed weight | 156 | 152 |
| (lbs) | | |
| Residence | 4.5 | 5.0 |
| time | | |
| (hr) | | |

TABLE 2

| | Comparative |
|---|---|
| Example | Example |
| 2 | B |

Conditions for gas-phase reactor

| | | |
|---|---|---|
| Reactor | 80 | 80 |
| Temperature | | |
| (° C.) | | |
| Reactor | 378 | 378 |
| Pressure | | |
| (psig) | | |
| C₂ partial | 200 | 201 |
| pressure | | |
| (psi) | | |
| H₂ to C₂ ratio | 0.000069 | 0.000134 |
| (mol/mol) | | |
| C₆ to C₂ ratio | 0.025 | 0.027 |
| (mol/mol) | | |
| Isopentane | 5.02 | 5.00 |
| (mol %) | | |
| C₂ feed rate | 42.8 | 47.0 |
| (lb/hr) | | |
| C₆ feed rate | 2.917 | 3.999 |
| (lb/hr) | | |
| H₂ feed rate | — | — |
| (millipound/hr) | | |
| Reactor vent | 11.5 | 19.8 |
| (lb/hr) | | |
| Zr feed rate | 0.019 | 0.017 |
| (from | | |
| zirconocene | | |
| g/hr) | | |
| Titanocene | 50.1 | — |
| solution feed | | |
| rate | | |
| (cm³/hr) | | |
| Titanium to | 0.272 | — |
| zirconium | | |
| (molar ratio) | | |
| Production rate | 36.0 | 36.2 |
| (lb/hr) | | |
| Bed weight | 191 | 185 |
| (lbs) | | |
| Residence | 5.3 | 5.1 |
| time | | |
| (hr) | | |

TABLE 3

| | Comparative |
|---|---|
| Example | Example |
| 3 | C |

Conditions for gas-phase reactor

| | | |
|---|---|---|
| Reactor | 75 | 75 |
| Temperature | | |
| (° C.) | | |
| Reactor | 378 | 377 |
| Pressure | | |
| (psig) | | |
| C₂ partial | 201 | 201 |
| pressure | | |
| (psi) | | |
| H₂ to C₂ ratio | 0.000079 | 0.000159 |
| (mol/mol) | | |
| C₆ to C₂ ratio | 0.034 | 0.034 |
| (mol/mol) | | |
| Isopentane | 3.00 | 2.99 |
| (mol %) | | |
| C₂ feed rate | 26.9 | 33.5 |
| (lb/hr) | | |
| C₆ feed rate | 2.727 | 3.713 |
| (lb/hr) | | |
| H₂ feed rate | — | — |
| (millipound/hr) | | |
| Reactor vent | 14.0 | 14.1 |
| (lb/hr) | | |
| Zr feed rate | 0.049 | 0.024 |
| (from | | |
| zirconocene | | |
| g/hr) | | |
| Titanocene | 26.1 | — |
| solution feed | | |
| rate | | |
| (cm³/hr) | | |
| Titanium to | 0.210 | — |
| zirconium | | |
| (molar ratio) | | |
| Production rate | 20.7 | 30.0 |
| (lb/hr) | | |
| Bed weight | 198 | 195 |
| (lbs) | | |
| Residence | 9.6 | 6.5 |
| time | | |
| (hr) | | |

A number of properties were determined for Examples 1-3 and Comparative Examples A-C, as well as compression plaques made from therefrom. The results are reported in Tables 3-11.

Density was determined according to ASTM D792-08.

Melt index (I₂, I₅, I₁₀ and I₂₁) was determined according to ASTM 1238-20.

Cumulative detector fraction (CDF_{LS}) was determined as discussed herein.

Weight average molecular weight (M_{w}(Conv)), number average molecular weight (Mₙ(Conv)), and Z-average molecular weight (M_{z}(Conv)) were determined by conventional gel permeation chromatography (GPC).

Absolute weight average molecular weight (M_{w}(Abs)), absolute number average molecular weight (Mₙ(Abs)), and absolute Z-average molecular weight (M_{z}(Abs)) were determined by absolute gel permeation chromatography (GPC).

High density fraction was determined as discussed herein, i.e., calculated as an integral from an iCCD curve from 93° C. to 119° C.

Short Chain Branching Distribution was determined as discussed herein, e.g., see paragraph [0048].

CDBI was determined as discussed herein, e.g., see paragraph [0044].

Zero shear viscosity was determined as discussed herein, e.g., see paragraph [0043].

Melt strength (190° C.) was determined by the Melt Strength Measurement process, as discussed herein, e.g., see paragraph [0045].

TABLE 4

| | Density | I₂ | I₅ | I₁₀ | I₂₁ | | |
|---|---|---|---|---|---|---|---|
| | (g/cm³) | (dg/min) | (dg/min) | (dg/min) | (dg/min) | I₂₁/I₅ | I₂₁/I₂ |
| Example | 0.920 | 0.166 | 0.44 | 1.01 | 2.89 | 6.5 | 17.4 |
| 1 | | | | | | | |
| Comparative | 0.919 | 0.271 | 0.73 | 1.67 | 4.80 | 6.6 | 17.7 |
| Example | | | | | | | |
| A | | | | | | | |

The data of Table 4 indicate that Example 1 and Comparative Example A have similar density values. The data of Table 4 indicate that Example 1 desirably had a melt index (I₂₁/I₂) ratio less than or equal to 18.5.

TABLE 5

| | Density | I₂ | I₅ | I₁₀ | I₂₁ | | |
|---|---|---|---|---|---|---|---|
| | (g/cm³) | (dg/min) | (dg/min) | (dg/min) | (dg/min) | I₂₁/I₅ | I₂₁/I₂ |
| Example | 0.914 | 0.169 | 0.43 | 1.00 | 2.88 | 6.8 | 17.1 |
| 2 | | | | | | | |
| Comparative | 0.915 | 0.323 | 0.82 | 1.89 | 5.38 | 6.5 | 16.7 |
| Example | | | | | | | |
| B | | | | | | | |

The data of Table 5 indicate that Example 2 and Comparative Example B have both similar density values. The data of Table 5 indicate that Example 2 desirably had a melt index (I₂₁/I₂) ratio less than or equal to 18.5.

TABLE 6

| | Density | I₂ | I₅ | I₁₀ | I₂₁ | | |
|---|---|---|---|---|---|---|---|
| | (g/cm³) | (dg/min) | (dg/min) | (dg/min) | (dg/min) | I₂₁/I₅ | I₂₁/I₂ |
| Example | 0.908 | 0.168 | 0.44 | 1.01 | 2.92 | 6.7 | 17.4 |
| 3 | | | | | | | |
| Comparative | 0.908 | 0.322 | 0.84 | 1.91 | 5.49 | 6.5 | 17.1 |
| Example | | | | | | | |
| C | | | | | | | |

The data of Table 6 indicate that Example 3 and Comparative Example C have both similar density values. The data of Table 6 indicate that Example 3 desirably had a melt index (I₂₁/I₂) ratio less than or equal to 18.5.

TABLE 7

| | Mn | Mw | Mz | Mw(Conv)/ | Mz(Conv)/ |
|---|---|---|---|---|---|
| | (Conv) | (Conv) | (Conv) | Mn | Mw |
| | g/mol | g/mol | g/mol | (Conv) | (Conv) |
| Example | 64,428 | 176,466 | 380,038 | 2.7 | 2.2 |
| 1 | | | | | |
| Comparative | 56,433 | 152,919 | 318,058 | 2.7 | 2.1 |
| Example | | | | | |
| A | | | | | |
| Example | 64,726 | 178,505 | 617,557 | 2.8 | 3.5 |
| 2 | | | | | |
| Comparative | 54,376 | 147,472 | 311,648 | 2.7 | 2.1 |
| Example | | | | | |
| B | | | | | |
| Example | 65,116 | 176,115 | 485,073 | 2.7 | 2.8 |
| 3 | | | | | |
| Comparative | 55,474 | 145,618 | 287,036 | 2.6 | 2.0 |
| Example | | | | | |
| C | | | | | |

The data of Table 7 indicate that each of Examples 1-3 desirably had a M_{w}/Mₙ from 2.5 to 3.2. The data of Table 7 indicate that each of Examples 1-3 desirably had a M_{z}/M_{w} from 1.7 to 4.5.

TABLE 8

| | | | | | | CDF_{LS} | |
|---|---|---|---|---|---|---|---|
| | | | | | | (at a | |
| | | | | | | molecular | |
| | | | | | | weight | 100*(0.0536 − |
| | Mn | Mw | Mz | | | (MW) | I₂₁*0.00224) |
| | (Abs) | (Abs) | (Abs) | Mw(Abs)/Mn | Mz(Abs)/Mw | of ≥1,000,000 | (reported as |
| | g/mol | g/mol | g/mol | (Abs) | (Abs) | g/mol) | percentage) |
| Example | 70,278 | 191,115 | 388,930 | 2.72 | 2.04 | 5.6% | 4.7% |
| 1 | | | | | | | |
| Comparative | 56,643 | 164,201 | 335,090 | 2.90 | 2.04 | 3.7% | 4.3% |
| Example | | | | | | | |
| A | | | | | | | |
| Example | 67,490 | 193,373 | 693,363 | 2.87 | 3.59 | 6.5% | 4.7% |
| 2 | | | | | | | |
| Comparative | 56,193 | 158,339 | 311,820 | 2.82 | 1.97 | 2.4% | 4.2% |
| Example | | | | | | | |
| B | | | | | | | |
| Example | 70,260 | 194,005 | 504,223 | 2.87 | 2.60 | 5.5% | 4.7% |
| 3 | | | | | | | |
| Comparative | 60,364 | 160,344 | 303,611 | 2.82 | 1.89 | 3.0% | 4.1% |
| Example | | | | | | | |
| C | | | | | | | |

The data of Table 8 indicate that each of Examples 1-3 desirably had a M_{w}(Abs)/Mₙ(Abs) from 2.5 to 3.2, a M_{z}(Abs)/M_{w}(Abs) from 1.7 to 4.5, and a CDF_{LS} at a molecular weight of ≥1,000,000 g/mol greater than 100*(0.0536−I₂₁*0.00224)%. The data of Table 8 indicate that each of Examples 1-3 desirably had a CDF_{LS} at a molecular weight of ≥1,000,000 g/mol greater than 4%.

TABLE 9

| | High | Short Chain | Composition |
|---|---|---|---|
| | density | Branching | Distribution |
| | fraction | Distribution | Branching |
| | (93-119° C.) | (wt %) | Index |
| Example | 24.1% | 18.0 | 56 |
| 1 | | | |
| Comparative | 18.7% | 15.5 | 60 |
| Example | | | |
| A | | | |
| Example | 15.2% | 25.0 | 57 |
| 2 | | | |
| Comparative | 14.0% | 24.9 | 59 |
| Example | | | |
| B | | | |
| Example | 11.9% | 35.2 | 60 |
| 3 | | | |
| Comparative | 8.9% | 33.8 | 66 |
| Example | | | |
| C | | | |

TABLE 10

| | Zero shear viscosity | Melt strength |
|---|---|---|
| | (Pa-sec) | (cN) |
| Example | 4.35(10\hat{ }04) | 9.3 |
| 1 | | |
| Comparative | 2.87(10\hat{ }04) | 6.0 |
| Example | | |
| A | | |
| Example | 4.29(10\hat{ }04) | 9.5 |
| 2 | | |
| Comparative | 2.25(10\hat{ }04) | 6.2 |
| Example | | |
| B | | |
| Example | 4.27(10\hat{ }04) | 10.3 |
| 3 | | |
| Comparative | 2.16(10\hat{ }04) | 6.4 |
| Example | | |
| C | | |

The data of Table 10 indicate that each of Examples 1-3 had an improved melt strength as respectively compared to Comparative Examples A-C.

Compression molded plaques were made according to ASTM D4703-16 per Annex A.1 Procedure C. Samples were compression molded at 190° C. into a 0.075 inch sheet, which was conditioned at 23±2° C. and 50±5% relative humidity for at least 24 hours before testing. Instrumented Dart Impact Total Energy (J) and Instrumented Dart Impact Peak Force (N) were determined according to ASTM D3763-18. The results are reported in Table 11.

TABLE 11

| | Instrumented | Instrumented |
|---|---|---|
| | Dart Impact | Dart Impact |
| | Peak Force | Total Energy |
| | (N) | (J) |
| Example | 328.5 | 11.0 |
| 1 | | |
| Comparative | 301.6 | 9.7 |
| Example | | |
| A | | |
| Example | 346.1 | 17.4 |
| 2 | | |
| Comparative | 299.9 | 14.5 |
| Example | | |
| B | | |
| Example | 334.1 | 17.0 |
| 3 | | |
| Comparative | 308.3 | 17.0 |
| Example | | |
| C | | |

The data of Table 11 indicate that each of Examples 1-3, in contrast to each of Comparative Examples A-C, desirably had an Instrumented Dart Impact (IDI) Peak Force greater than 315 N and a CDF_{LS} at a molecular weight of ≥1,000,000 g/mol greater than 4.0% (as reported in Table 8). The data of Table 11 further indicate that Example 1 had an improved IDI Peak Force as compared to Comparative Example A; Example 2 had an improved IDI Peak Force as compared to Comparative Example B; and Example 3 had an improved IDI Peak Force as compared to Comparative Example C.

Recycled polyethylene, (Natura LDPE PCR 100) was obtained from Avangard Innovative. A number of properties were determined for the recycled polyethylene. The results are reported in Table 12. Density was determined according to ASTM D792-08, Melt index (12) was determined according to ASTM D1238-20, Ash content was determined according to D5630, Moisture content was determined according to ASTM D6980, Color was determined according to ASTM D6290-19.

TABLE 12

| | Recycled polyethylene |
|---|---|
| Density | 0.910-0.925 |
| (g/cm³) | |
| I₂ | 1.8-2.8 |
| (dg/min) | |
| Ash | ≤1.0 |
| Content | |
| (%) | |
| Moisture | ≤0.05 |
| Content | |
| (%) | |
| Color | ≥40 |
| (L*) | |

Example 1-1, a thermoplastic composition, was made by a film process described below. Example 1-2 was made as Example 1-1, with any changes reported in Table 13.

Examples 3-1 and 3-2 were made as Example 1-1; however, Example 3 was used rather than Example 1, with any changes reported in Table 13.

Comparative Examples A-1 and A-2 made as Example 1-1; however, Comparative Example A was used rather than Example 1, with any changes reported in Table 13.

Comparative Examples C-1 and C-2 made as Example 1-1; however, Comparative Example C was used rather than Example 1, with any changes reported in Table 13.

TABLE 13

| | | Virgin Raw | Recycled |
|---|---|---|---|
| | Virgin Raw | polymer | polyethylene |
| | polymer | amount | amount |
| | utilized | (wt %) | (wt %) |
| Example | Example 1 | 75 | 25 |
| 1-1 | | | |
| Comparative | Comparative | 75 | 25 |
| Example | Example A | | |
| A-1 | | | |
| Example | Example 1 | 50 | 50 |
| 1-2 | | | |
| Comparative | Comparative | 50 | 50 |
| Example | Example A | | |
| A-2 | | | |
| Example | Example 3 | 75 | 25 |
| 3-1 | | | |
| Comparative | Comparative | 75 | 25 |
| Example | Example C | | |
| C-1 | | | |
| Example | Example 3 | 50 | 50 |
| 3-2 | | | |
| Comparative | Comparative | 50 | 50 |
| Example | Example C | | |
| C-2 | | | |

Monolayer blown films of 2.0 mil thickness targets were respectively Blown films were made from Examples 1-1, 1-2,3-1, 3-2 and Comparative Examples A-1, A-2, C-1, C-2 using a 2″ die diameter blown film line. Gravimetric feeders dosed resin formulations into a Labtech LTE20-32 twin screw extruder at rate of 15 lbs/hr. From the extruder the resin formulation is conveyed into the 2″ die diameter die with gap of 1.0 mm. The LTE opening feed throat was set to 193° C. and the remaining barrel, conveying portion, and die temperature were set and maintained to 215° C. To produce films an output rate of 2.4 lb/hr/in. of die circumference and melt temperature of 215° C. was targeted with pressurized ambient air inflating the film bubble to a 2.5 blow-up ratio. A dual lip air ring driven by a variable speed blower was used for all experiments. The frost line height (FLH) was maintained between 9.3 and 10.3 inches. Film thickness was targeted at 2 mils and was controlled within ±10% by adjusting the nip roller speed. The films are wound up into a roll.

Instrumented Dart Impact Total Energy (J) and Instrumented Dart Impact Peak Force (N) were determined according to ASTM D3763-18. The results are reported in Table 14.

TABLE 14

| | Instrumented Dart | Instrumented Dart |
|---|---|---|
| | Impact Peak Force | Impact Total Energy |
| | (N) | (J) |
| Example | 52.1 | 1.16 |
| 1-1 | | |
| Comparative | 47.1 | 1.05 |
| Example | | |
| A-1 | | |
| Example | 34.4 | 0.49 |
| 1-2 | | |
| Comparative | 29.6 | 0.43 |
| Example | | |
| A-2 | | |
| Example | 83.8 | 6.45 |
| 3-1 | | |
| Comparative | 72.2 | 5.16 |
| Example | | |
| C-1 | | |
| Example | 74.4 | 5.51 |
| 3-2 | | |
| Comparative | 66.4 | 4.72 |
| Example | | |
| C-2 | | |

The data of Table 14 indicate that in the presence of 25 wt % recycled polyethylene, Example 1-1 had an improved IDI Peak Force as compared to Comparative Example A-1 and Example 3-1 had an improved IDI Peak Force as compared to Comparative Example C-1; in the presence of 50 wt % recycled polyethylene, Example 1-2 had an improved IDI Peak Force as compared to Comparative Example B-2 and Example 3-2 had an improved IDI Peak Force as compared to Comparative Example C-2.

1. An ethylene/1-hexene copolymer, wherein the ethylene/1-hexene copolymer has a density from 0.850 to 0.940 g/cm³, a melt index (I₂₁) from 0.1 to 50 dg/min, a melt index (I₂₁/I₂) ratio less than or equal to 18.5, a M_{w}(Abs)/Mₙ(Abs) from 2.0 to 3.5, a M_{z}(Abs)/M_{w}(Abs) from 1.7 to 4.5, and a cumulative detector fraction (CDF_{LS}) at a molecular weight of ≥1,000,000 g/mol of greater than 100*(0.0536−I₂₁*0.00224)%.

2. The ethylene/1-hexene copolymer of claim 1, wherein the density is from 0.870 to 0.930 g/cm³ and the melt index (I₂₁) is from 1.0 to 10 dg/min and the ethylene/1-hexene copolymer has a M_{z}(Abs) from 350,000 to 900,000 g/mol, a high density fraction (93-119° C.) from 5% to 30%, a short chain branching distribution from 10 to 50, and a composition distribution breadth index from 35 to 80.

3. The ethylene/1-hexene copolymer of any claim 1, wherein the ethylene/1-hexene copolymer has an Instrumented Dart Impact (IDI) Peak Force greater than 315 Newtons and a cumulative detector fraction (CDF_{LS}) at a molecular weight of ≥1,000,000 g/mol of greater than 4%.

4. An ethylene/1-hexene copolymer, wherein the ethylene/1-hexene copolymer has a density from 0.850 to 0.940 g/cm³, a melt index (I₂₁) from 0.1 to 10 dg/min, an Instrumented Dart Impact (IDI) Peak Force greater than 315 Newtons, and a cumulative detector fraction (CDF_{LS}) at a molecular weight of ≥1,000,000 g/mol of greater than 4%.

5. The ethylene/1-hexene copolymer of claim 4, wherein the ethylene/1-hexene copolymer has a melt strength from 7 to 15 cN.

6. The ethylene/1-hexene copolymer of claim 4, wherein the ethylene/1-hexene copolymer has a cumulative detector fraction (CDF_{LS}) at a molecular weight of ≥1,000,000 g/mol of greater than 100*(0.0536−I₂₁*0.00224)%.

7. A thermoplastic composition comprising from 0.5 wt % to 75.0 wt % of a recycled polyethylene and from 25.0 wt % to 99.5 wt % of the ethylene/1-hexene copolymer of claim 1; wherein at least 90.0 wt % of the thermoplastic composition is comprised of the recycled polyethylene and the ethylene/1-hexene copolymer;
wherein the recycled polyethylene comprises either a first blend of polyethylenes recovered from post-consumer material, a second blend of polyethylenes recovered from pre-consumer material, or a combination of the first and second blends; and
wherein the recycled polyethylene has:
a density of from 0.900 g/cm³ to 0.940 g/cm³ when measured according to ASTM D792-08, Method B;
a melt index (I₂) of from 0.30 dg/min to 6.00 dg/min when measured according to ASTM D1238-10, Method B, at 190° C. and a 2.16 kg load.

8. A method for increasing Instrumented Dart Impact (IDI) Peak Force, the method comprising:
contacting a zirconocene catalyst and a hydrogenation catalyst with ethylene and 1-hexene in a gas-phase reactor under polymerizable conditions, wherein the zirconocene catalyst and the hydrogenation catalyst have a titanium to zirconium molar ratio from 0.100 to 0.700; and
making an ethylene/1-hexene copolymer having a density from 0.850 to 0.940 g/cm³ and an Instrumented Dart Impact (IDI) Peak Force greater than 315 Newtons and a cumulative detector fraction (CDF_{LS}) at a molecular weight of ≥1,000,000 g/mol of greater than 4%.

9. The method of claim 8, wherein the ethylene/1-hexene copolymer has a melt strength from 7 to 15 cN.

10. The method of claim 8 wherein the ethylene/1-hexene copolymer is the ethylene/1-hexene copolymer of a claim 1.

11. A thermoplastic composition comprising from 0.5 wt % to 75.0 wt % of a recycled polyethylene and from 25.0 wt % to 99.5 wt % of the ethylene/1-hexene copolymer of any one of claims 1 to 6 (e.g., the ethylene/1-hexene copolymer of claim 4; wherein at least 90.0 wt % of the thermoplastic composition is comprised of the recycled polyethylene and the ethylene/1-hexene copolymer;
wherein the recycled polyethylene comprises either a first blend of polyethylenes recovered from post-consumer material, a second blend of polyethylenes recovered from pre-consumer material, or a combination of the first and second blends; and
wherein the recycled polyethylene has:
a density of from 0.900 g/cm³ to 0.940 g/cm³ when measured according to ASTM D792-08, Method B;
a melt index (I₂) of from 0.30 dg/min to 6.00 dg/min when measured according to ASTM D1238-10, Method B, at 190° C. and a 2.16 kg load.

12. The method of claim 8 wherein the ethylene/1-hexene copolymer is the ethylene/1-hexene copolymer of claim 4.
